(19) United States
(12) Patent Application Publication
(10) Pub. No.: US 2002/0018538 A1
(43) Pub. Date: Feb. 14, 2002

(54) Method to increase loading of isotopic fuel into a metal

(76) Inventor: Mitchell R. Swartz, Weston, MA (US)

Correspondence Address: Mitchell R. Swartz, ScD, MD, EE, 16 Pembroke Road, Weston, MA, 02493, US

(21) Appl. No.: 09/748,695

(22) Filed: Dec. 26, 2000

Related U.S. Application Data
(62) Division of application No. 07/760,970, filed on Sep. 17, 1991.

(51) Int. Cl. G21J 1/00; G21B 1/00

(52) U.S. Cl. 376/100

(57) ABSTRACT

The present invention relates to methods and apparatus to increase the loading of isotopic fuels in a metal, such as hydrogen within palladium. The method and apparatus uses an electrical system with anode and cathode, each composed of the same metal with the electrochemical anodic sacrifice of the anode composed of said metal, and an electrolyte containing said metal as an ion and containing said isotopic fuel, thereby codepositing said fuel and said metal ions upon the cathode to increase the loading. In one configuration the anode has a cruciform shape. In the preferred embodiment, means are provided for coaxial loading from a concentric outer cathode.

The present invention relates to methods and apparatus to increase the loading of isotopic fuels in a metal, such as hydrogen within palladium. The method and apparatus uses an electrical system with anode and cathode, each composed of the same metal with the electrochemical anodic sacrifice of the anode composed of said metal, and an electrolyte containing said metal as an ion and containing said isotopic fuel, thereby codepositing said fuel and said metal ions upon the cathode to increase the loading. In one configuration the anode has a cruciform shape. In the preferred embodiment, means are provided for coaxial loading from a concentric outer cathode.

By way of background and to place reasonable limits on the size of this disclosure, the following publications are noted:

U.S. PATENT DOCUMENTS

| Ser. No. | Filing Date | |
|---|---|---|
| 07/339,976 | 04/18/1989 | Swartz, M. R., “Systems to Increase |

the Efficiency, Control, Safety and Energy Utilization of
Electrochemically Induced Fusion Reactions”.

| | | |
|---|---|---|
| 07/371,937 | 06/27/1989 | Swartz, M. R., “Systems to Monitor |

and Accelerate Electrochemically Induced Fusion Reactions”.

### Foreign Patent Documents

### Other Publications

The present invention relates to electrochemical reactions in or about metals, such as palladium which has been electrochemically loaded with deuterium, but it has relevance as well, to hydrogen storage, fuel cells, nuclear fusion, and other reactions in pressure-loaded metals such as titanium or palladium filled with deuterium, and to the broader field of metallurgy and engineering in or about metals, including Groups IVb, Vb, and some rare earths.

The following journal articles and papers and may be used by way of background material and to supplement this specification:

C. A. HAMPEL, Rare Metals Handbook, Reinhold Publishing Corp, (1954).

M. HANSEN, Constitution of Binary Alloys, McGraw-Hill Book Co. Inc (1958).

C. J. SMITHELLS, Metals Reference Book, Butterworths Scientific, (1949).

H. H. UHLIG, Corrosion and Corrosion Control, John Wiley & Sons, Inc., (1971).

Controlled reactions in loaded metals offer the possibility of more efficient and inexpensive energy.

However, there are problems. First, the desired reactions are not well controlled. The proven difficulties of loading, the slow initiation of the desired reactions, and the difficulty in controlling the reactions has limited research and development of this technology.

Second, prior to the desired reactions, the cathodes must be filled with deuterons to concentrations which require significant times of charging.

Third, palladium, the preferred metal of these reactions, is expensive.

Fourth, the rates of the desired reactions are very low in the steady state.

Accordingly, it is a principal object of the present invention to provide a novel method and apparatus to increase the loading of isotopic fuels in a metal, such as hydrogen within palladium.

Another object of the present invention is to minimize the required quantity of expensive palladium used.

Another object of the present invention is to decrease the time required to obtain the desired reactions.

Another object of the present invention is to maximize the local quantity of the hydrogen within the palladium.

These and still further objects are addressed hereinafter.

The foregoing objects are achieved in a method which includes in combination supplying an electrical system to an anode and cathode, each composed of said metal, anodically sacrificing the anode composed of said metal, utilizing an electrolyte containing said metal as an ion and containing said isotopic fuel, and codepositing said fuel and said metal ions upon the cathode, with the result of thereby increasing the loading.

The invention is hereafter described with reference to the accompanying drawings in which:

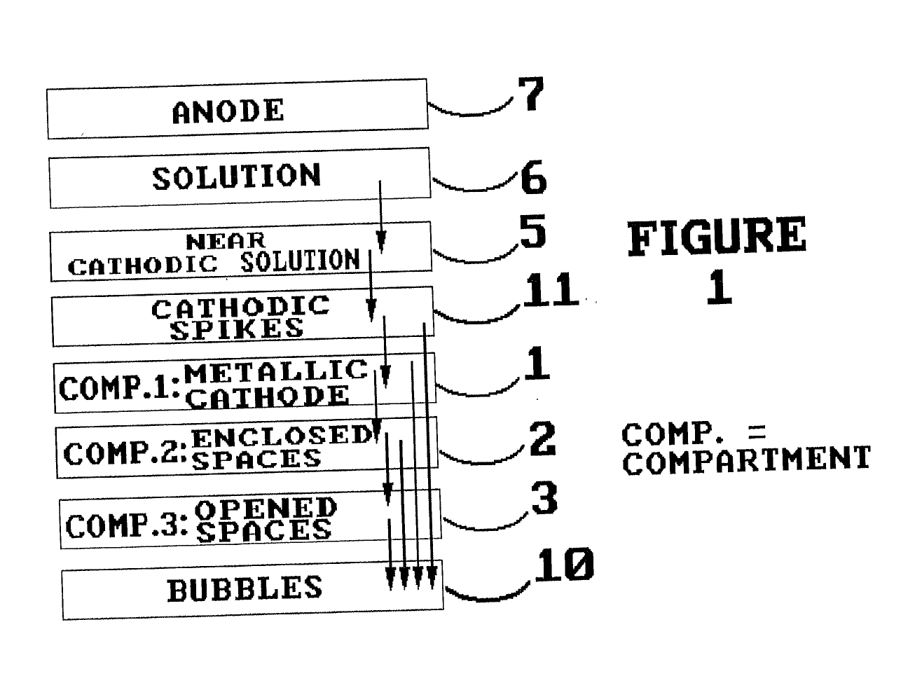

FIG. 1 symbolically shows the compartments used to analyze an electrochemical reactor. The cathode is dissected into four region, and three compartments within the metal itself. The flow of deuterons is shown by arrows.

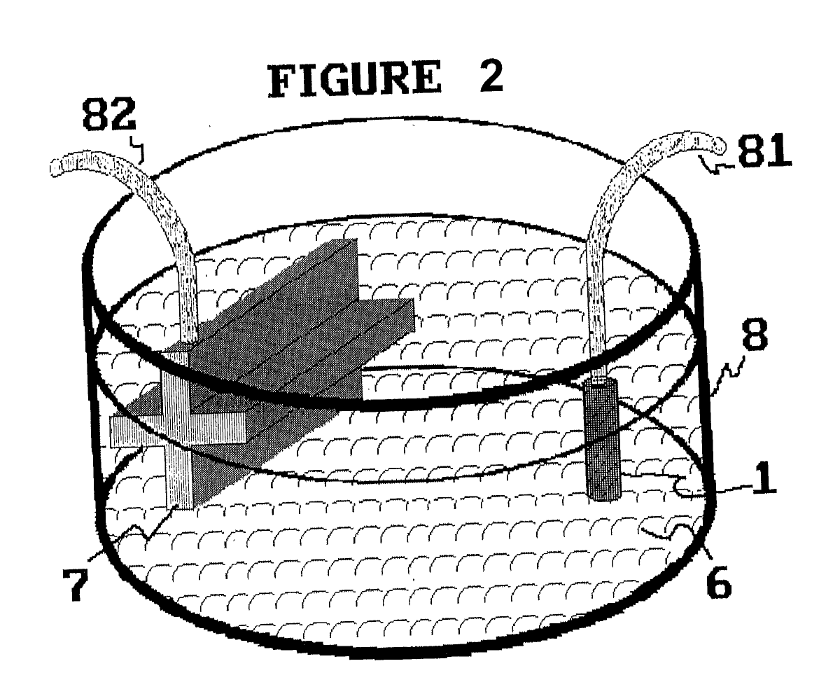

FIG. 2 shows a typical experimental setup with a cruciform sacrificial cathode of palladium.

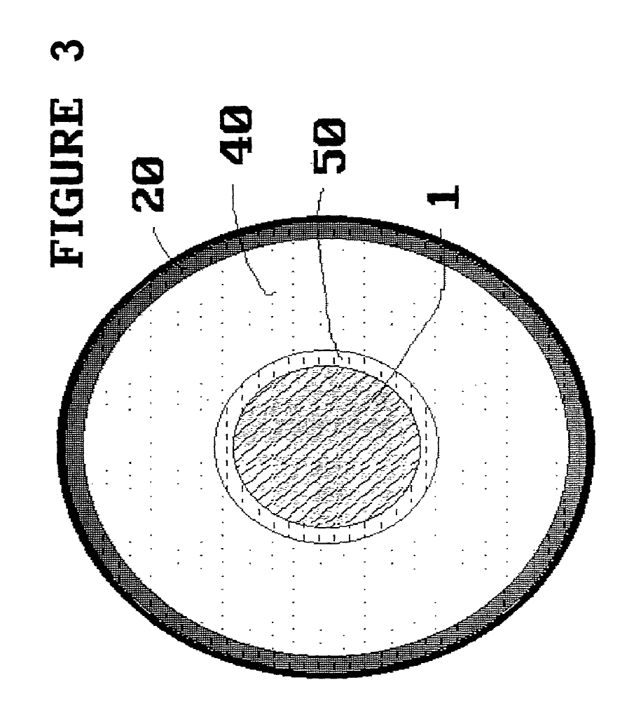

FIG. 3 shows a vertical cross-sectional slice of a device, showing structural external casing support system, a centrally placed axially-filled cathode, a coaxial deuteron-barrier and coaxial expansion-barrier.

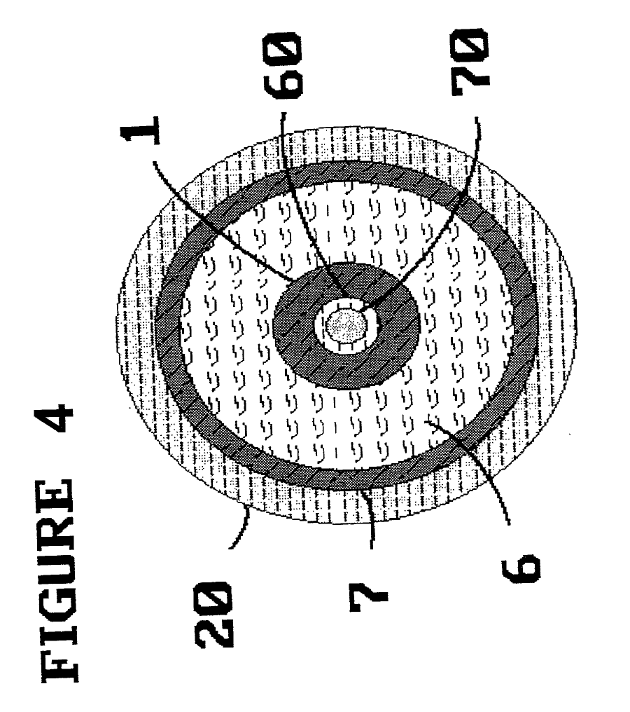

FIG. 4 shows a vertical cross-sectional slice of a device with a coaxially-filled cathode. The electric fields are in the radial direction. Also shown are an inner coaxial deuteron-barrier and thermal pipe.

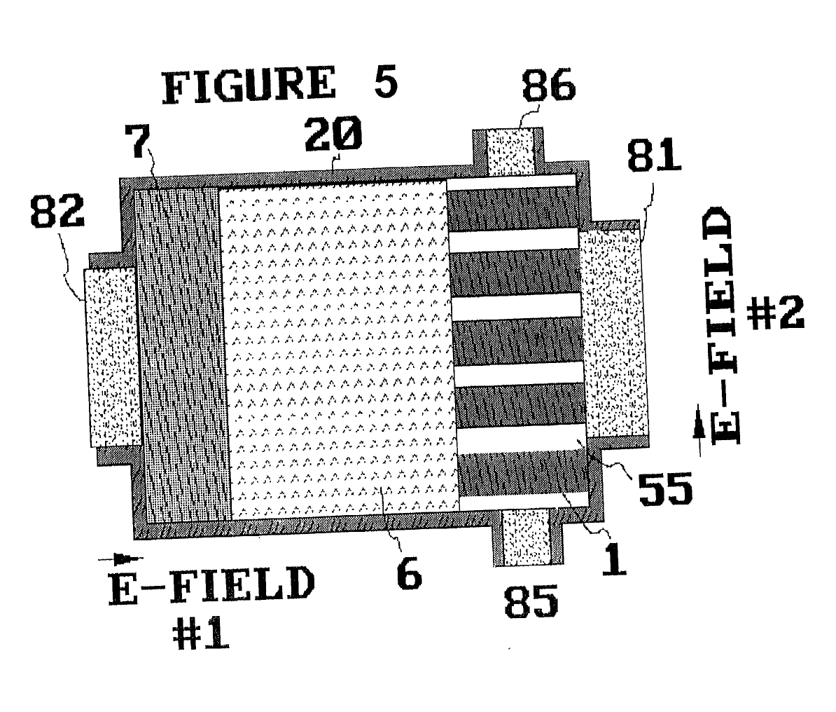

FIG. 5 is a crossectional drawing of a lamellar CAM reactor. This device has two orthogonal applied electric fields. The second applied electric field intensity is delivered after full charging. Between these slabs of the cathode alternate deuteron-impermeable barriers.

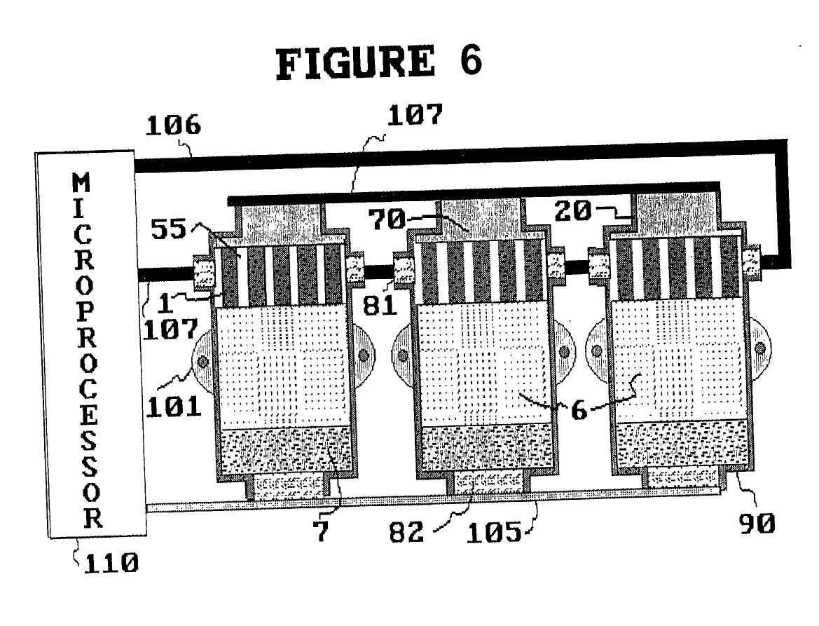

FIG. 6 shows three lamellar CAM reactors. Each device is equipped with orthogonal applied electric fields. Said apparatus has a thermal bus connected to the heat pipes which are held within a mechanical connecting system.

Turning now to the figures: FIG. 1 symbolically shows the compartments used to analyze an electrochemical reactor. FIG. 1 gives organization to the different parts of a simple reactor referred to in this disclosure. It is not meant to be physically realistic with respect to size. The cathode is dissected into four regions. Three compartments are shown within the metal itself. The flow of deuterons is shown by arrows. The label 1 represents the metallic cathode, usually palladium in the preferred configuration. The labels 2 and 3 represents compartments 2, and 3 respectively, which are discussed in detail below. The label 7 represents the anode which in the preferred embodiment is composed of palladium. The label 6 represents the solution consisting in the preferred embodiment of a gel containing antidesiccant, in combination with LiOD, palladium salts, and heavy water (D2O).

The power supply and control unit consists of a current source and reactor control device as described in Swartz (1989), and are not shown in the figure. For simplicity, the electrical connections, heat removing apparatus, and several improvements described in this disclosure are not shown in FIG. 1.

The application of said power source creates an applied electric field intensity which produces cation flow towards the cathode. There results in the near cathode solution (labelled as 5 in FIG. 1) a buildup of deuterons, and a low dielectric constant (gas bubble) layer. The bubbles are labelled as number 10 in FIG. 1. There may be spikes or on the cathode (labelled as 11 in FIG. 1).

Turning now to FIG. 2 shows a typical experimental setup, but with a novel cruciform-shaped sacrificial anode of palladium in a solution (labelled 7). The preferred solution (6) contains palladium salts, lithium deuteroxide, and heavy water. The cruciform shape is the preferred shape of the anode in that as it is sacrificed to the solution (enabling efficient codeposition of palladium and deuterons) the surface area most nearly remains constant during its decomposition of said sacrificial anode. The connections to the electrodes are labelled as 81 and 82. The reaction vessel is labelled 8. The cathode is labelled as number 1.

This type of system, coupled with the drive system, is capable of filling of the cathode with deuterium from the solution. However, the deuterated metals could also be filled by codeposition of deuterium and palladium, or by high pressure deuterium gas.

In the following devices, palladium is the described preferred embodiment for the cathodes, but members of the group consisting of vanadium, tantalum, niobium, lanthanum and cerium may also be used.

FIG. 3 shows a vertical cross-sectional slice of a CAM device, having a external structural casing support system, a centrally placed axially-filled cathode, a coaxial deuteron-barrier and coaxial expansion-barrier. The structural support system (labelled 20) encloses an axially-filled cathode for the desired reactions consisting of a coaxial deuteron-barrier and coaxial expansion-barrier. The expansion barrier (labelled 40) surrounds the cathode and prevents expansion. Between the two is a deuteron impermeable barrier (labelled 50) which prevents outward diffusion of deuterons when the cathode is catastrophically desaturated of its deuterons. The barrier prevents loss of deuterons to the expansion barrier, and acts a circumferential locus of the desired reactions. The cathode is labelled as 1. In this CAM device, the cathode is charged in a direction perpendicular to the drawing.

FIG. 4 shows a vertical cross-sectional slice through a novel CAM coaxial device with a coaxially-filled cathode, and an inner coaxial deuteron-barrier and thermal pipe. This embodiment is in a cylindrical configuration. The electric fields are in the radial direction. This device is characterized by coaxial loading of the cathode with deuterons (labelled 1). In the figure, the anode is circumferential to the cathode, and is labelled as 7. The solution (labelled 6) consists of lithium deuteroxide, palladium deuteroxide, and heavy water as the preferred embodiment. The inner diffusion barrier (labelled 60, and consisting of gold in the preferred embodiment) and the inner thermal pipe (labelled 70, and consisting of a diamond filament in the preferred embodiment) are shown in crossection. The heat energy is extracted from the center. In this CAM device, the activation current is supplied between 1 and 7. The barrier (70) acts to provide a geometric focus at which the desired reactions occur. The heat is extracted through thermal pipe (70) which in the preferred embodiment is diamond, or composites of diamond (eg. thermally conductive epoxy filled with diamonds).

FIG. 5 is a crossectional drawing of a lamellar CAM reactor. This device has two orthogonal applied electric fields. The first (labelled E-field number 1 in the the figure) is that which is applied to charge the palladium with deuterons. The second applied electric field intensity is delivered after full charging has been achieved. In the figure the anode and cathode are labelled as 7 and 1. The electrolyte solution or gel is labelled as 6. The connections for the first electric field are labelled as 81 and 82.

The connections for the second electric field are labelled as 85 and 86. The mechanical casing is labelled 20. The deuteron impermeable barrier is comb-shaped in this preferred configuration, and is labelled 55 in FIG. 5. The cathode in this preferred configuration is divided into parallel slabs. Between these slabs alternate deuteron-impermeable barriers. Application of the second electric field causes the deuterons already loaded in the cathode to redistribute, but the deuteron-impermeable barrier(s) act to enhance the desired reactions.

The 4-terminal CAM device shown in FIG. 5 does not show, for simplicity, the thermal transfer equipment or these parts needed for superassembly as described above.

Turning to FIG. 6 which shows three lamellar CAM reactors. Each device is equipped with orthogonal applied electric fields. The second applied electric field intensity is delivered after full charging. Each reactor is labelled as 90 in FIG. 6, similar to what is shown in FIG. 5. These devices each contain a cathodes (labelled 1), intradevice gel containing lithium and palladium deuteroxide (labelled 6), and anode (labelled 7). These CAM devices are inserted, similar to a fuse onto a holding board (not shown), held in place by clips (labelled 101).

The three CAM device are shown connected to a microprocessor control system (labelled 110). Said apparatus has an electrical bus to connect the anodes (labelled 105) which are connected to the anodic connectors (labelled 82). Said apparatus has an electrical bus to connect the cathodes (labelled 106 and 107) which are connected to the cathodic connectors (not labelled in the figure). The cathodic system buses (106 and 107) are electrically shorted together during the deuterium charging. Said apparatus has a thermal bus (labelled 107) connected to the heat pipes (labelled 70) which are held in a mechanical connecting system (labelled 20). The result is the piling up of deuterium at the deuteron-impermeable barriers (labeled 55 in FIG. 6). The energy is directed out via the the heat pipes (70) and the thermal bus (107). After loading the cathodes, the cathodic buses (106 and 107) are separated and a second electric potential is supplied between these two buses.

The purpose of the receptor apparatus is first to integrate the three (or more) CAM units. The three cathodic connectors are connected to the control apparatus. The damage or rundown of one CAM unit is thus easily exchanged or corrected by replacement with a functional one.

Modification of the invention herein disclosed will occur to persons skilled in the art and all such modifications are deemed to be within the scope of the invention as defined by the appended claims.

What is claimed is:

1. In a process for producing a product using a metal loaded with an isotopic fuel, a method to to increase the loading of said metal by electrochemical means that includes:
supplying an electrical system to an anode and cathode, each composed of said metal,
anodically sacrificing the anode composed of said metal,
utilizing an electrolyte containing said metal as an ion and containing said isotopic fuel, and
codepositing said fuel and said metal ions upon the cathode thereby increasing the loading.

2. In a method as in claim 1, where the isotopic fuel is a member of the group consisting of an isotope of hydrogen, boron, lithium, or potassium.

3. In a method as in claim 1, where the metal is a member of the group consisting of palladium, titanium, niobium, or nickel or their alloys.

4. In a method as in claim 1 wherein said metal is palladium, and said isotopic fuel is an isotope of hydrogen, and wherein said electrolyte contains heavy water.

5. In a method as in claim 4 wherein said electrolyte contains palladium deuteroxide or palladium ions.

6. In a method as in claim 4 wherein said electrolyte contains lithium deuteroxide or lithium ions.

7. In a method as in claim 1 where said cathode is coaxially-loaded from an concentric outer cathode.

8. In a method as in claim 1 where said anode is in a cruciform shape.

9. In a method as in claim 1 where said method includes means for removing a damaged or not active reactor.

10. In a method as in claim 1 where said method includes means for adding a deuteron-impermeable barrier.

11. An apparatus to produce a product using a metal loaded with an isotopic fuel, which includes in combination:
means to supply an electrical system to an anode and cathode, each composed of said metal,
means to anodically sacrifice the anode composed of said metal,
means to utilize an electrolyte containing said metal as an ion and containing said isotopic fuel,
means to codeposit said fuel and said metal ions upon the cathode.

12. An apparatus as in claim 1 1, where the isotopic fuel is a member of the group consisting of an isotope of hydrogen, boron, lithium, or potassium.

13. An apparatus as in claim 11, where the material is a member of the group consisting of palladium, titanium, or nickel.

14. An apparatus as in claim 11 wherein said metal is palladium, and said isotopic fuel is an isotope of hydrogen, and wherein said electrolyte contains heavy water.

15. An apparatus as in claim 13 wherein said electrolyte contains palladium deuteroxide or palladium ions.

16. An apparatus as in claim 13 wherein said electrolyte contains lithium deuteroxide or lithium ions.

17. An apparatus as in claim 11 where said cathode is coaxially-loaded from an concentric outer cathode.

18. An apparatus as in claim 11 where said anode is in a cruciform shape.

19. An apparatus as in claim 11 where said apparatus includes removeable reactors.

20. An apparatus as in claim 11 where said apparatus includes a deuteron-impermeable barrier.
